(19) United States
(12) Patent Application Publication
(10) Pub. No.: US 2012/0007797 A1
(43) Pub. Date: Jan. 12, 2012

(54) HUMAN-MACHINE INTERFACE

(75) Inventor: Chien-Hsing Huang, Taipei County (TW)

(73) Assignee: KINPO ELECTRONICS, INC., Taipei County (TW)

(21) Appl. No.: 12/844,121

(22) Filed: Jul. 27, 2010

(30) Foreign Application Priority Data
Jul. 8, 2010 (TW) 99122524

(51) Int. Cl. G09G 5/00

(52) U.S. Cl. 345/156

(57) ABSTRACT

A human interface suitable for being held is provided. The human interface includes a first housing, a second housing and a rotating shaft. The first housing has a first sidewall and a sliding chunk, and the sliding chunk is located at a side of the first sidewall. The second housing having a second sidewall and a sliding trough is disposed under the first housing, wherein the sliding trough is located at one side of the second sidewall. The sliding chunk is disposed in the sliding trough. The rotating shaft is pivotally connected between the first housing and the second housing and located at a side of the first housing apart from the sliding chunk. The sliding chunk of the first housing slides in the sliding trough of the second housing, and the first housing rotates relative to the second housing by using the rotating shaft as a rotating center.

### CROSS-REFERENCE TO RELATED APPLICATION

This application claims the priority benefit of Taiwan application serial no. 99122524, filed on Jul. 8, 2010. The entirety of the above-mentioned patent application is hereby incorporated by reference herein and made a part of specification.

### BACKGROUND

1. Field of the Invention

The invention relates to a human-machine interface. More particularly, the invention relates to a human-machine interface suitable for comfortable utilization.

2. Description of Related Art

In today's information age, people increasingly depend on electronic products. To cope with demands of high performance and portability of the electronic devices, the electronic devices such as notebook personal computers (PCs), cell phones, personal digital assistants (PDAs), and digital personal stereos become indispensable application tools in people's daily life and work. Each of the above electronic devices has a human-machine interface, which is used for inputting a user's instruction, so that an internal system of the electronic product can automatically execute such instruction, and the most widely used human-machine interface includes electronic devices such as keyboards, mice and touch pads.

Taking the mouse as an example, the mouse generally has a housing and a circuit board module disposed in the housing. The housing mainly includes a lower housing and an upper housing assembled to the lower housing, wherein the upper housing has a holding portion suitable for being held by a user. Generally, the upper housing is fabricated into a shape suitable for being held by the user. However, since an individual utilization habit of each user is different, not all of hand holding shapes of the users opportunely match a shape of the upper housing. Moreover, since computer-using time of modern people becomes longer, when the user uses the mouse for a long period of time while holding the mouse in a same pose, the user cannot adjust the mouse holding pose as the computer-using time increases, which is not comply with ergonomics.

### SUMMARY

The invention is directed to a human-machine interface, in which a usage angle can be adjusted according to a utilization requirement of a user, so that the user can comfortably use such human-machine interface.

The invention provides a human-machine interface suitable for being held by a hand. The human-machine interface includes a first housing, a second housing and a rotating shaft. The first housing has a first sidewall and a sliding chunk, and the sliding chunk is located at a side of the first sidewall. The second housing having a second sidewall and a sliding trough is disposed under the first housing, wherein the sliding trough is located at a side of the second sidewall. The sliding chunk of the first housing is disposed in the sliding trough. The rotating shaft is pivotally connected between the first housing and the second housing and located at a side of the first housing apart from the sliding chunk. The sliding chunk of the first housing slides in the sliding trough of the second housing, and the first housing rotates relative to the second housing by using the rotating shaft as a rotating center.

In an embodiment of the invention, the sliding trough has an arc shape, and the rotating shaft serves as an arc center of the arc shape. The rotating shaft is a pivot or a convex shaft, and one end of the convex shaft is connected to the first sidewall, and the second sidewall further has a sliding slot, and another end of the convex shaft is disposed in the sliding slot. Moreover, two ends of the sliding trough respectively have an extending part, and the extending parts extend along a radial direction of the sliding trough.

In an embodiment of the invention, the second housing further has two third sidewalls perpendicularly connected to two opposite sides of the second sidewall. Moreover, the human-machine interface further includes an elastic element, wherein one end of the elastic element is connected to the third sidewall close to the sliding slot, and another end of the elastic element is connected to the convex shaft.

In an embodiment of the invention, the first housing further has two fourth sidewalls perpendicularly connected to two opposite sides of the first sidewall, wherein the two third sidewalls are located between the two fourth sidewalls.

In an embodiment of the invention, the human-machine interface further includes at least one circuit board disposed between the first housing and the second housing, wherein the first housing further has a holding portion located above the first sidewall, and the holding portion has a plurality of buttons electrically connected to the circuit board. Moreover, the human-machine interface further includes a light sensing module disposed between the first housing and the second housing, wherein the light sensing module is electrically connected to the circuit board. In addition, the human-machine interface further includes a wheel disposed on the holding portion, and the wheel is electrically connected to the circuit board.

According to the above descriptions, the first housing of the human-machine interface can be rotated relative to the second housing by taking the rotating shaft as a rotating center. Therefore, when the user uses the human-machine interface, an angle between the first housing and the second housing can be adjusted according to a personal habit, so that the user can be more comfortable in utilization.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a human-machine interface according to an embodiment of the invention.

FIG. 2 is an appearance schematic diagram of a human-machine interface.

FIG. 3 is a partial perspective view of a human-machine interface.

FIG. 4 is a schematic diagram of a human-machine interface of FIG. 1 having a first housing rotated relative to a second housing by an angle.

FIG. 5 is a schematic diagram of a human-machine interface of FIG. 2 having a first housing rotated relative to a second housing by an angle.

FIG. 6 is a schematic diagram of a human-machine interface of FIG. 3 having a first housing rotated relative to a second housing by an angle.

FIG. 7 is a schematic diagram illustrating another disposing method of a rotating shaft.

FIG. 8 is a schematic diagram illustrating a human-machine interface according to another embodiment of the invention.

FIGS. 9-11 are schematic diagrams illustrating a process that one side of a first housing rotates to elevate relative to the second housing while taking a rotating shaft as a rotating center.

FIG. 12 is a schematic diagram illustrating a human-machine interface including an elastic element.

### DETAILED DESCRIPTION OF DISCLOSED EMBODIMENTS

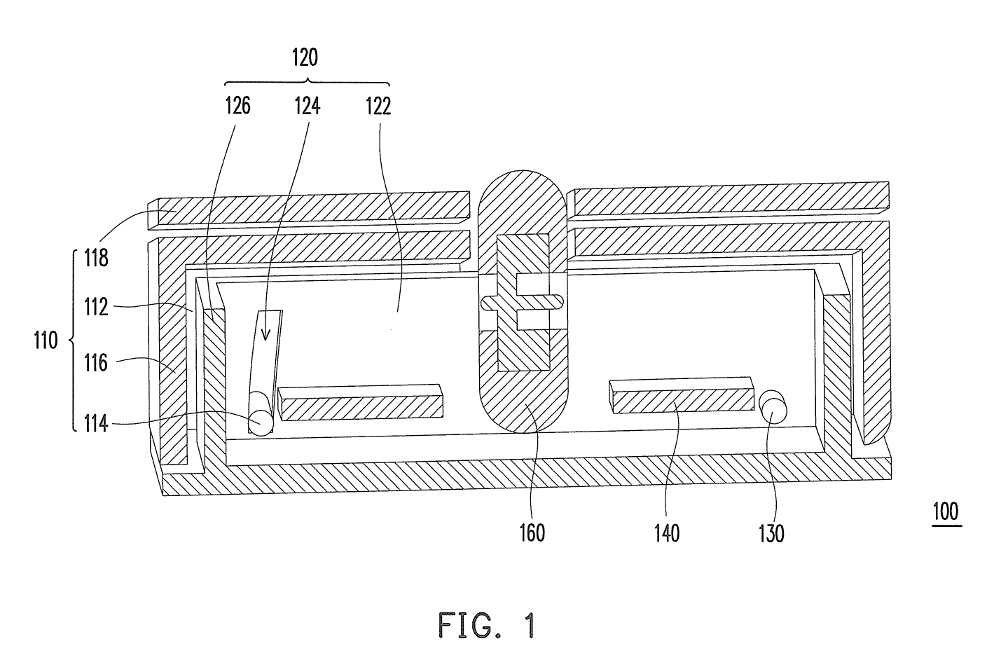

FIG. 1 is a schematic diagram illustrating a human-machine interface according to an embodiment of the invention. Referring to FIG. 1, the human-machine interface 100 is suitable for being held by a hand of a user, and includes a first housing 110, a second housing 120 and a rotating shaft 130. The first housing 110 has a first sidewall 112 and a sliding chunk 114, and the sliding chunk 114 is located at a side of the first sidewall 112. The second housing 120 is disposed under the first housing 110, and has a second sidewall 122 and a sliding trough 124, wherein the sliding trough 124 is located at a side of the second sidewall 122, and the sliding chunk 114 of the first housing 110 is disposed in the sliding trough 124. The rotating shaft 130 is pivotally connected between the first housing 110 and the second housing 120 and is located at a side of the first housing 110 apart from the sliding chunk 114.

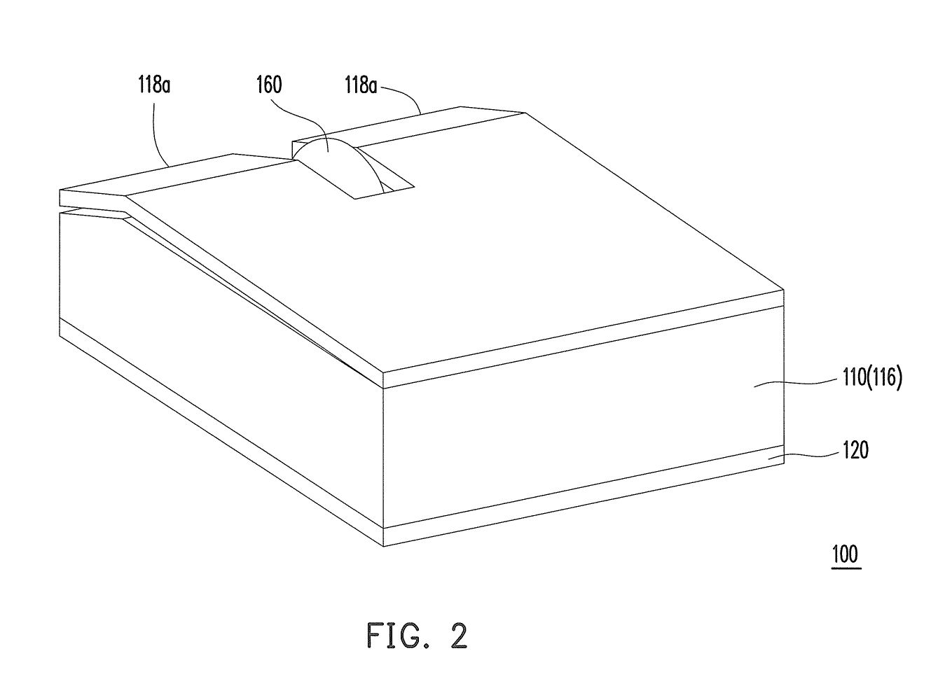

The sliding trough 124 has an arc shape, and the rotating shaft 130 serves as an arc center of the arc shape. The rotating shaft 130 is, for example, a pivot. Moreover, the second housing 120 further has two third sidewalls 126 perpendicularly connected to two opposite sides of the second sidewall 122, and the first housing 110 further has two fourth sidewalls 116 perpendicularly connected to two opposite sides of the first sidewall 112. When the first housing 110 and the second housing 120 are assembled, the two third sidewalls 126 are located between the two fourth sidewalls 116. FIG. 2 is an appearance schematic diagram of the human-machine interface. Referring to FIG. 1 and FIG. 2, the first housing 110 further has a holding portion 118 located above the first sidewall 112, and the holding portion 118 has a plurality of buttons 118a (two buttons 118a are schematically illustrated in FIG. 2).

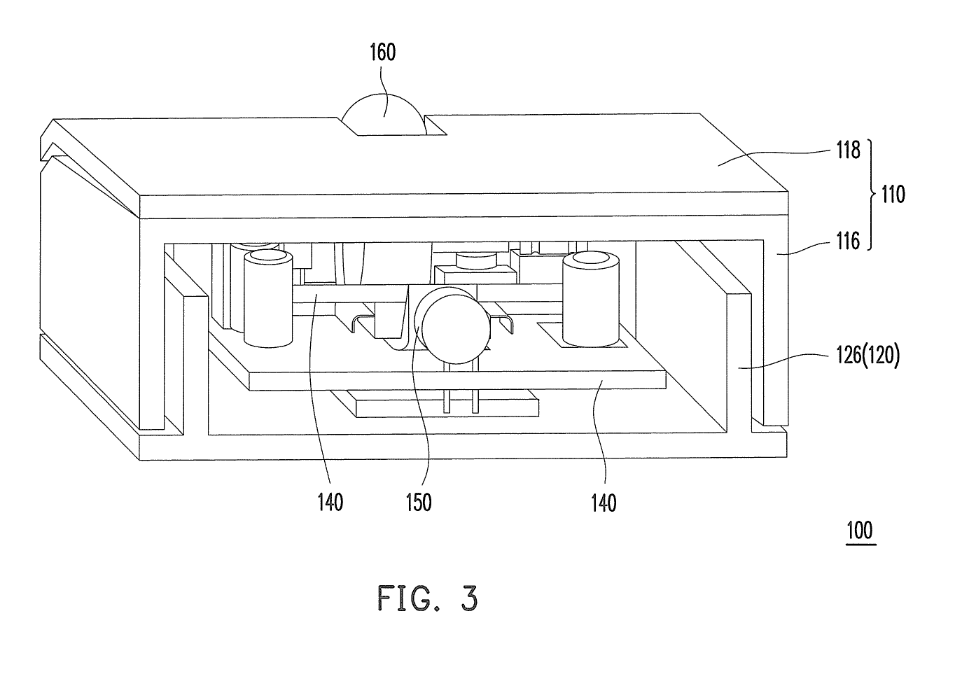

FIG. 3 is a partial perspective view of the human-machine interface. Referring to FIG. 1 and FIG. 3, the first housing 110 and the second housing 120 of the present embodiment are hollow, and the human-machine interface 100 further includes at least one circuit board 140 (two circuit boards 140 are schematically illustrated in FIG. 3) disposed between the first housing 110 and the second housing 120, and a light sensing module 150 electrically connected to the circuit board 140, wherein the buttons 118a are also electrically connected to the circuit board 140. Referring to FIG. 1, FIG. 2 and FIG. 3, the human-machine interface 100 further includes a wheel 160 disposed on the holding portion 118. The wheel 160 can be disposed between the two buttons 118a, and protrudes out from the holding portion 118, so that the user can roll the wheel 160 by a finger. The wheel 160 is electrically connected to the circuit board 140, and the wheel 160 can be a mechanic wheel or an optical wheel, which is determined according to a utilization requirement.

Referring to FIG. 1, FIG. 2 and FIG. 3, when the user uses the human-machine interface 100 of the present embodiment, the user can slightly put a whole palm on the human-machine interface 100, wherein the palm can be located on the holding portion 118, tail ends of the forefinger and the middle finger can put on the two buttons 118a, and the thumb and the little finger can slightly lean against the two fourth sidewalls 116, which is a general holding mode. The user can move the human-machine interface 100, and the light sensing module 150 may sense and calculate a moving direction and a moving distance of the human-machine interface 100, so as to accordingly move a cursor displayed on a screen (not shown) electrically connected to the human-machine interface 100. The user can also press the button 118a located at the left side or the button 118a located at the right side to input and execute instructions. Moreover, the user can also roll the wheel 160 by the finger, so as to scroll a window up and down.

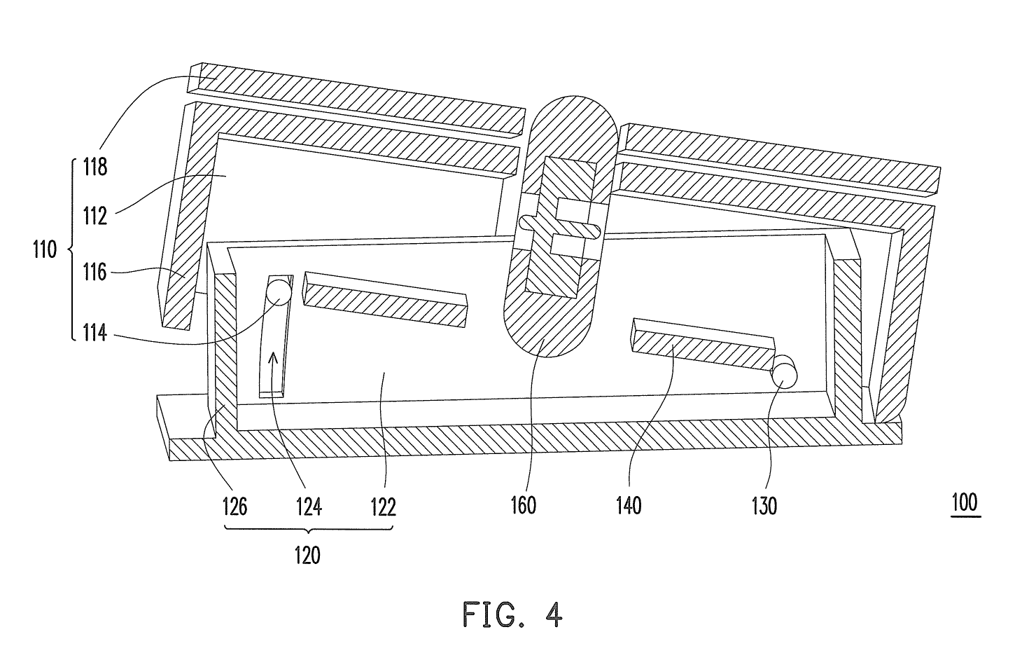

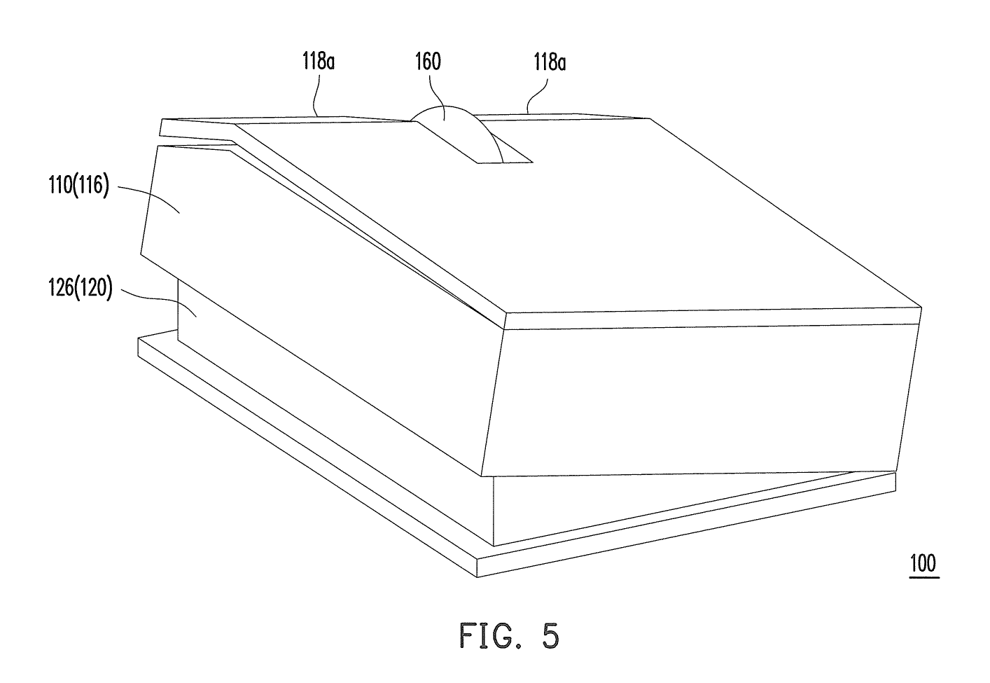

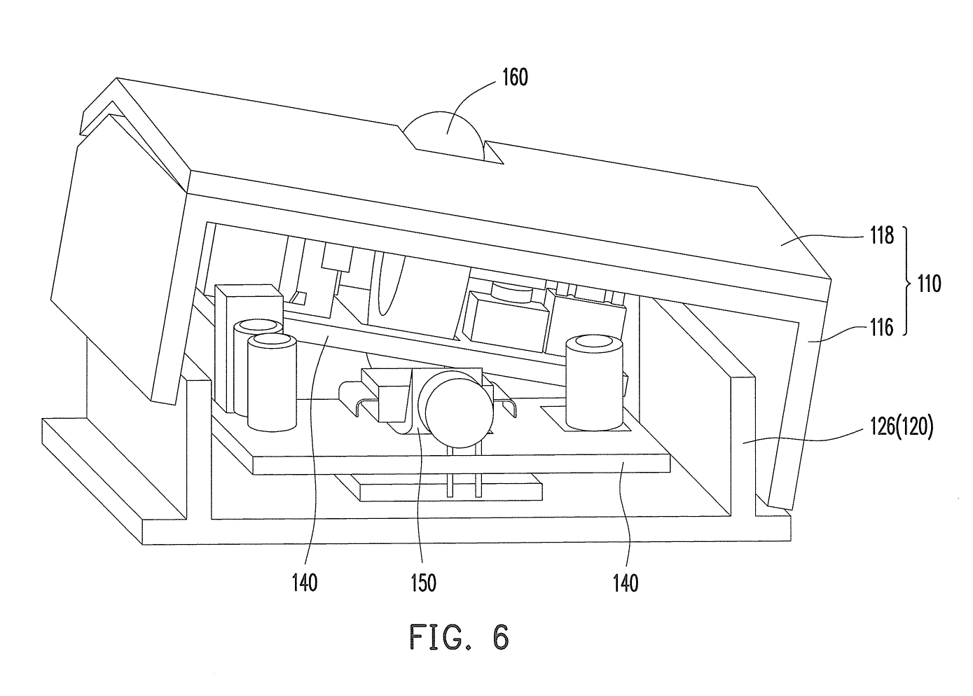

FIG. 4 is a schematic diagram of the human-machine interface of FIG. 1 having the first housing rotated relative to the second housing by an angle, FIG. 5 is a schematic diagram of the human-machine interface of FIG. 2 having the first housing rotated relative to the second housing by an angle, and FIG. 6 is a schematic diagram of the human-machine interface of FIG. 3 having the first housing rotated relative to the second housing by an angle. Referring to FIG. 4, FIG. 5 and FIG. 6, the user can adjust a relative position between the first housing 110 and the second housing 120 of the human-machine interface 100 according to a utilization habit, so as to comfortably hold the human-machine interface 100 during utilization. In detail, the user can take the rotating shaft 130 (serving as a pivot) as a rotating center to slide the sliding chunk 114 of the first housing 110 in the arc-shape sliding trough 124 of the second housing 120, so that the first housing 110 rotates relative to the second housing 120. Moreover, the sliding trough 124 can be designed to have steps, so that the user can select a rotation angle of the first housing 110 relative to the second housing 120 according to the utilization requirement, or can adjust the rotation angle of the first housing 110 relative to the second housing 120 through the pivot.

It should be noticed that when the first housing 110 rotates relative to the second housing 120 to elevate one side of the first housing 110, the third sidewall 126 can shield the circuit board 140 and the light sensing module 150 located between the first housing 110 and the second housing 120, so as to maintain a whole visual effect of the human-machine interface 100.

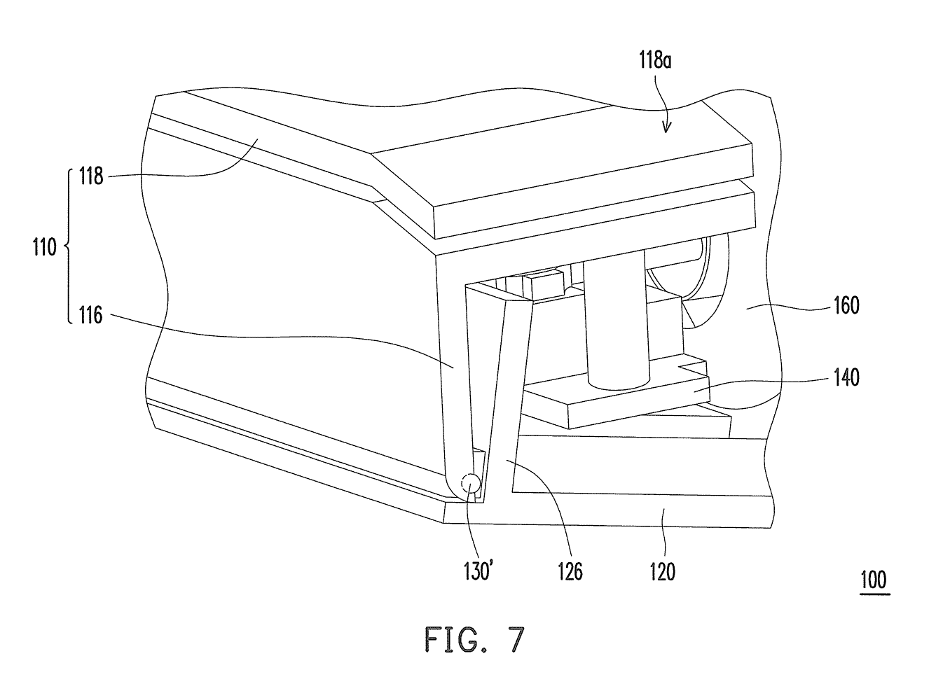

FIG. 7 is a schematic diagram illustrating another disposing method of the rotating shaft. FIG. 3 and FIG. 6 are diagrams of the human-machine interface 100 of FIG. 5 viewed from a backside B thereof, and FIG. 7 is diagram of the human-machine interface 100 viewed from a front side F thereof. Referring to FIG. 5 and FIG. 7, the rotating shaft 130′ serving as the pivot can be formed integrally with the fourth sidewall 116, and a shape thereof can be a column. The third sidewall 126 has an opening or a slot (not shown), so that the column can be inserted therein.

According to the above descriptions, in the human-machine interface 100 of the present embodiment, by using the rotating shaft 130 in collaboration with the sliding chunk 114 of the first housing 110 and the sliding trough 124 of the second housing 120, when the user holds the human-machine interface 100 of the present embodiment, the user can take the rotating shaft 130 as the rotating center to rotate the first housing 110 relative to the second housing 120 according to the utilization requirement, so as to elevate one side of the first housing 110 by a rotation angle for utilization. Since the rotation angle of the first housing 110 relative to the second housing 120 is determined by the user according to the utilization requirement, the user can use such human-machine interface 100 in a more comfortable pose, which complies with ergonomics.

To ensure those skilled in the art easily understanding the spirit of the invention, shapes of the first housing 110 and the second housing 120 of the human-machine interface 100 in figures are simply illustrated by straight lines. Though a line shape or a whole shape of the human-machine interface 100 can also be changed according to an actual requirement without departing from the spirit of the invention. For example, the first housing 110 and the second housing 120 can also be fabricated into a streamline shape, an arc shape or other shapes, so as to match a hand shape of the user to achieve a comfortable utilization effect complied with the ergonomics.

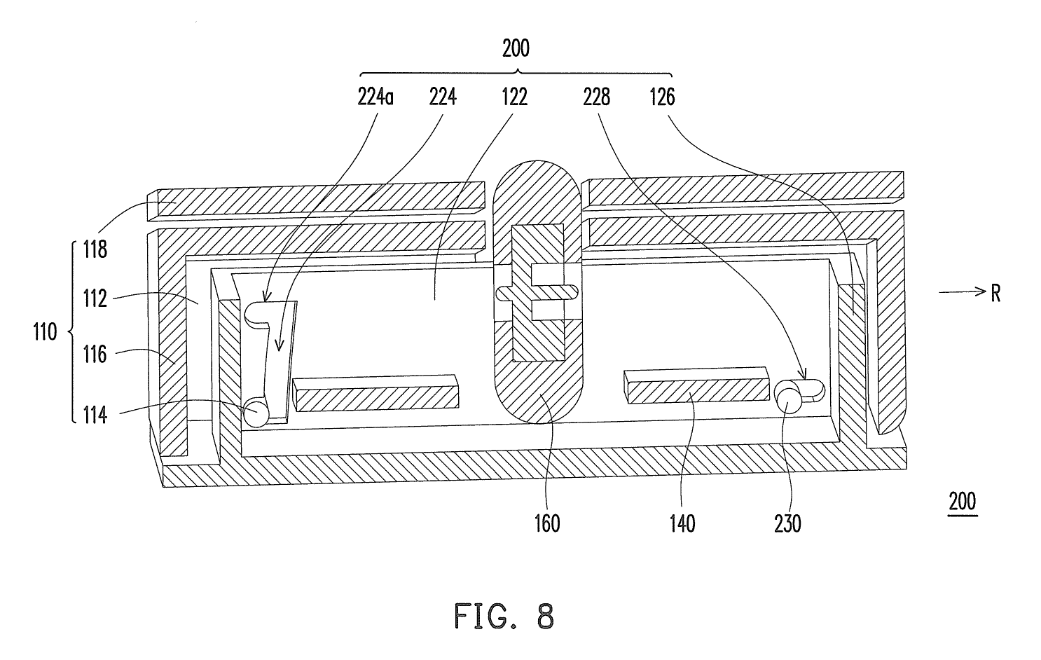

FIG. 8 is a schematic diagram illustrating a human-machine interface according to another embodiment of the invention. Referring to FIG. 8, in the human-machine interface 200 of the present embodiment, the rotating shaft 230 can be a convex shaft. One end of the convex shaft is connected to the first sidewall 112, and the second sidewall 122 further has a sliding slot 228 at a side departing from the sliding trough 224, and another end of the convex shaft is disposed in the sliding slot 228. Moreover, two ends of the sliding trough 224 respectively have an extending part 224a, and the extending parts 224a extend along a radial direction of the arc-shaped sliding trough 224.

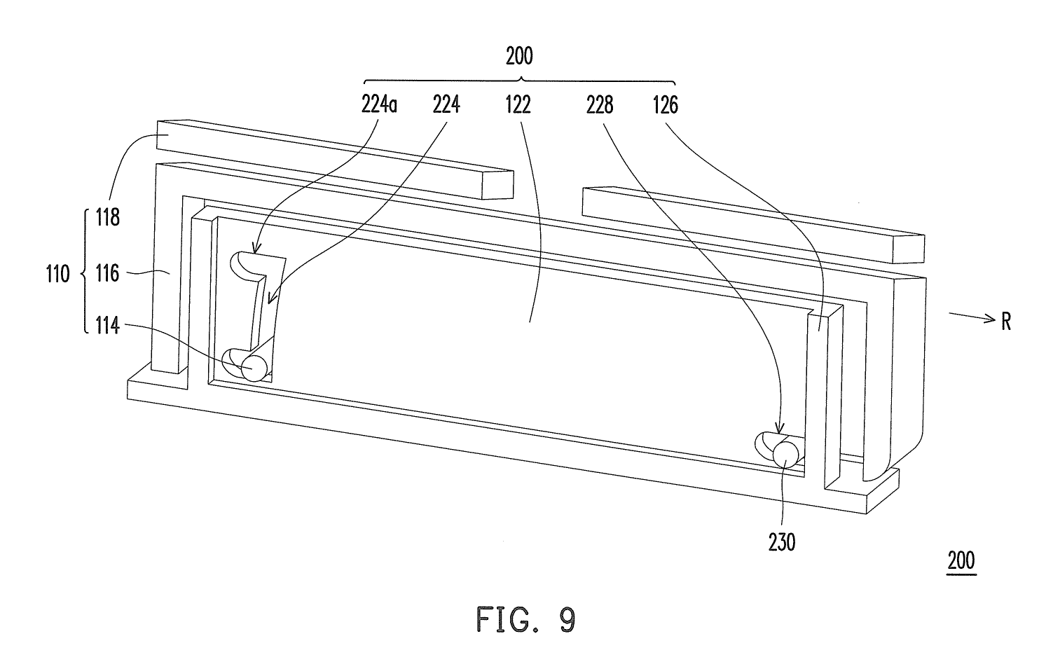

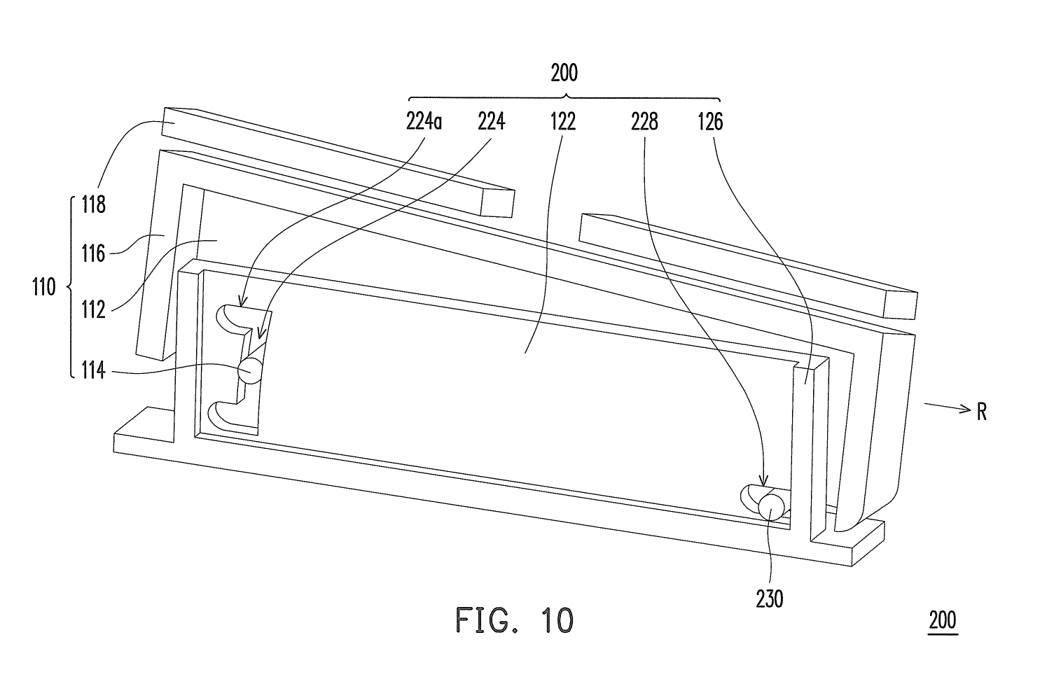

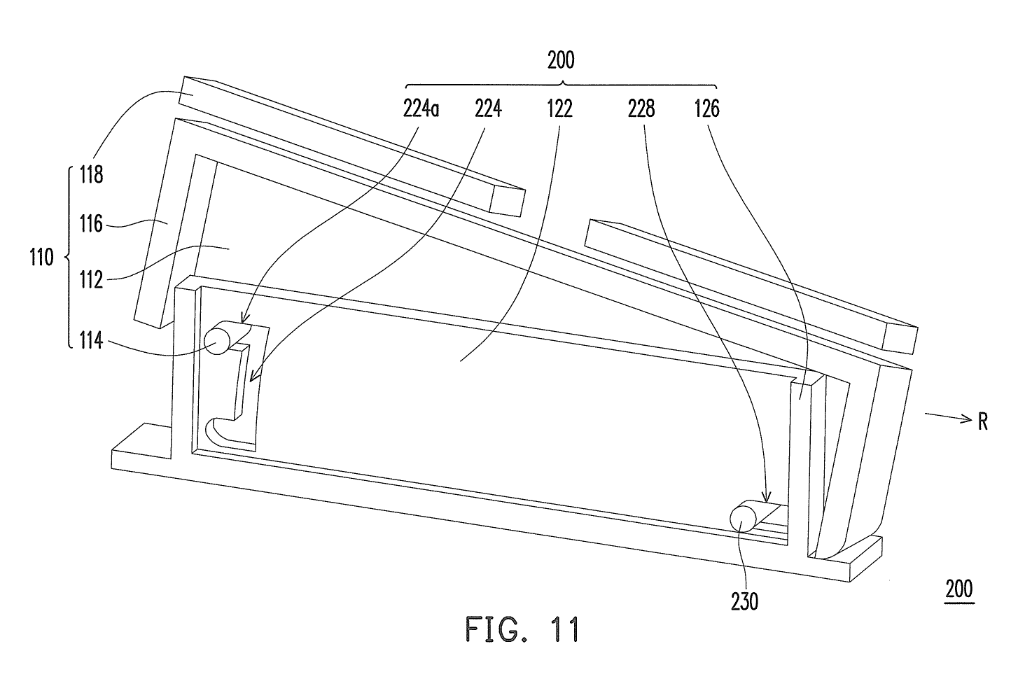

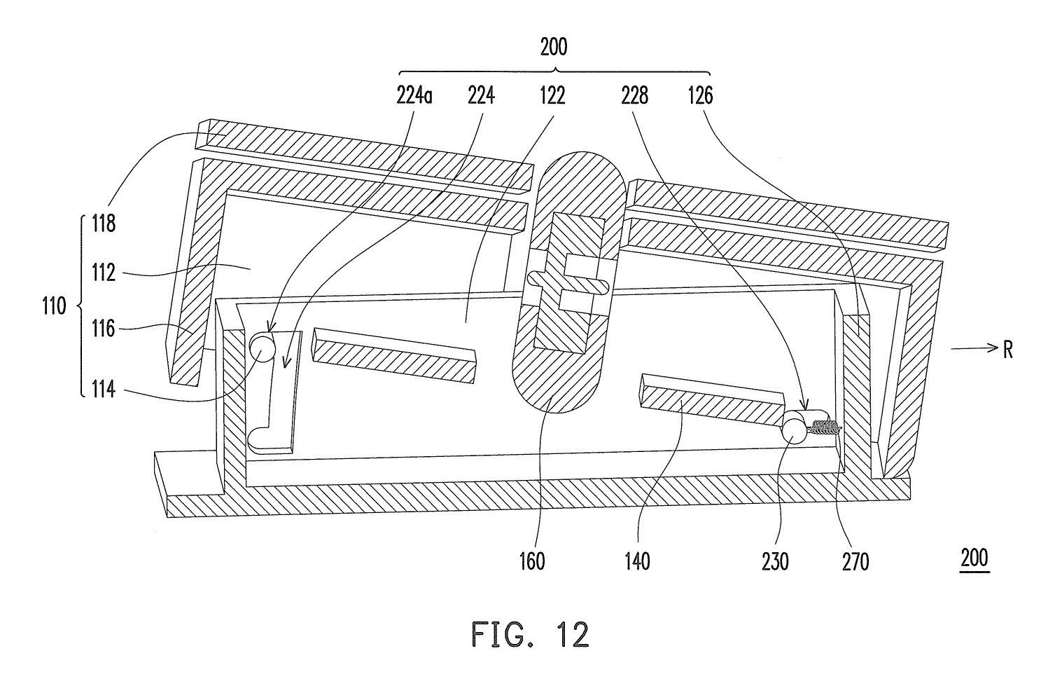

FIGS. 9-11 are schematic diagrams illustrating a process that one side of the first housing rotates to elevate relative to the second housing while taking the rotating shaft as the rotating center, in which only the first housing, the second housing and the rotating shaft are illustrated, and the other components are omitted. Referring to FIG. 8, FIG. 9 and FIG. 10, when the user wants to change the angle of one side of the first housing 110 relative to the second housing 220, the user first exerts force to move the first housing 110 relative to the second housing 220 along a right direction R, and now the rotating shaft 230 also moves in the sliding slot 228 along the right direction R, and meanwhile the chunk 114 enters a main part (not marked) of the sliding trough 224 having the arc shape from the extending part 224a located below. After the chunk 114 enters the main part of the sliding trough 224 having the arc shape, a mutual limitation between the sliding chunk 114 and the extending part 224a is released, so that the sliding chunk 114 can move along the main part of the sliding trough 224 having the arc shape. Then, referring to FIG. 11 and FIG. 12, when the sliding chunk 114 moves in the sliding trough 224 for a suitable distance, the user can further move the first housing 110 along an reversed direction of the right direction R to slide the sliding chunk 114 into the extending part 224a located above, so as to limit the position of the sliding chunk 114, and meanwhile the rotating shaft 230 is also moved along the reversed direction of the right direction R within the sliding slot 228. It should be noticed that although the extending parts 224a are disposed at two ends of the sliding trough 224 in FIGS. 9-11, a plurality of extending part 224a can also be suitably configured according an actual requirement, so that the user can adjust an elevating angle of one side of the first housing 110 rotated relative to the second housing 220 by himself.

FIG. 12 is a schematic diagram illustrating a human-machine interface including an elastic element. Referring to FIG. 12, the human-machine interface 200 may further include an elastic element 270. One end of the elastic element 270 is connected to the third sidewall 126 closed to the sliding slot 228, and another end of the elastic element 270 is connected to the rotating shaft 230 serving as the convex shaft. The elastic element 270 is, for example, a spring. In this way, after the sliding chunk 114 moves in the sliding trough 224 for a suitable distance, the user is unnecessary to exert any force, and the rotating shaft 230 is driven by an elastic restoring force of the elastic element 270 and is moved to its original position in the sliding slot 228, so as to drive the sliding chunk 114 to move into the extending part 224a.

In summary, in the human-machine interface, by using the rotating shaft in collaboration with the sliding chunk of the first housing and the sliding trough of the second housing, when the user holds the human-machine interface of the invention, the user can adjust the rotation angle of one side of the first housing relative to the second housing according to the utilization requirement. Since the rotation angle of the first housing relative to the second housing is determined by the user according to the utilization requirement, the user may use such human-machine interface in a more comfortable pose, so as to avoid civilization diseases of the user caused by long time use of the human-machine interface to comply with the ergonomics.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A human-machine interface, suitable for being held by a hand, and the human-machine interface comprising:
a first housing, having a first sidewall and a sliding chunk, wherein the sliding chunk is located at a side of the first sidewall;
a second housing, disposed under the first housing, and having a second sidewall and a sliding trough, wherein the sliding trough is located at a side of the second sidewall, and the sliding chunk of the first housing is disposed in the sliding trough; and
a rotating shaft, pivotally connected between the first housing and the second housing, and located at a side of the first housing apart from the sliding chunk, wherein the sliding chunk of the first housing slides in the sliding trough of the second housing, and the first housing rotates relative to the second housing by using the rotating shaft as a rotating center.

2. The human-machine interface as claimed in claim 1, wherein the sliding trough has an arc shape, and the rotating shaft serves as an arc center of the arc shape.

3. The human-machine interface as claimed in claim 2, wherein the rotating shaft is a pivot.

4. The human-machine interface as claimed in claim 2, wherein two ends of the sliding trough respectively have an extending part, and the extending parts extend along a radial direction of the sliding trough.

5. The human-machine interface as claimed in claim 4, wherein the rotating shaft is a convex shaft, one end of the convex shaft is connected to the first sidewall, and the second sidewall further has a sliding slot, and another end of the convex shaft is disposed in the sliding slot.

6. The human-machine interface as claimed in claim 5, wherein the second housing further has two third sidewalls perpendicularly connected to two opposite sides of the second sidewall.

7. The human-machine interface as claimed in claim 6, further comprising an elastic element, wherein one end of the elastic element is connected to the third sidewall close to the sliding slot, and another end of the elastic element is connected to the convex shaft.

8. The human-machine interface as claimed in claim 6, wherein the first housing further has two fourth sidewalls perpendicularly connected to two opposite sides of the first sidewall, wherein the third sidewalls are located between the fourth sidewalls.

9. The human-machine interface as claimed in claim 1, further comprising at least one circuit board disposed between the first housing and the second housing.

10. The human-machine interface as claimed in claim 9, wherein the first housing further has a holding portion located above the first sidewall, and the holding portion has a plurality of buttons electrically connected to the at least one circuit board.

11. The human-machine interface as claimed in claim 9, further comprising a light sensing module disposed between the first housing and the second housing, and electrically connected to the at least one circuit board.

12. The human-machine interface as claimed in claim 10, further comprising a wheel disposed on the holding portion, and electrically connected to the at least one circuit board.
